(19) United States
(12) Patent Application Publication
(10) Pub. No.: US 2009/0196606 A1
(43) Pub. Date: Aug. 6, 2009

(54) OPTICAL ACCESS NETWORK AND OPTICAL SWITCHING SYSTEMS

(76) Inventors: Morihito MIYAGI, (US); Hiroki Ikeda, Hachioji (JP); Kenichi Sakamoto, Kokubunji (JP); Nobuko Miyagi, Hayama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/363,015

(22) Filed: Jan. 30, 2009

(30) Foreign Application Priority Data
Feb. 4, 2008 (JP) 2008-023448

(51) Int. Cl. H04J 14/00

(52) U.S. Cl. 398/45

(57) ABSTRACT

An optical access network and optical switching systems requiring no frame delay process on an optical switchboard are disclosed. Plural ONUs are connected to user terminals. An OLT communicates with an IP network through an access gateway. An optical switching unit (OSW) connects the ONUs and the OLT by switching the optical line. A control line connects the OLT and the OSW to control the optical switch change-over operation in the OSW. The optical switch port information required to generate the optical switch activation signal are concentrated in the OLT, which transmits the optical switch change-over control signal to the OSW through the control line before the transmission frame.

### INCORPORATION BY REFERENCE

The present application claims priority from Japanese application JP 2008-023448 filed on Feb. 4, 2008, the content of which is hereby incorporated by reference into this application.

### BACKGROUND OF THE INVENTION

1. Technical Field

This invention relates to an optical access network and an optical line switching control system, or in particular, to an optical access network for switching the optical line using an optical switching unit and a system for controlling the operation of switching the optical line.

2. Related Art

In order to access various sites of the internet (IP network) at high speed, the ADSL (Asymmetrical Digital Subscriber Line) utilizing the existing public telephone line and the PON (Passive Optical Network) using a new optical fiber find wide applications. In the PON system, the communication of plural optical network units (ONU) connected to terminals is controlled by a single optical line terminal (OLT). The OLT and the plural ONUs are connected to each other through a splitter. The splitter, though having the advantage of low cost as a passive part, distributes the optical signal, and therefore, harbors the problem of confidentiality in view of the fact that the ONU originally not adapted for communication can monitor the signals of other parts. Also, since the optical signal is distributed, the optical signal strength at the receiving end decreases with the number of distributees, thereby posing the problem that the communicable distance is shortened.

To solve these problem points of the PON system, a method has been conceived to switch the communication path of the optical signal with an optical switch instead of distributing the optical signal with the splitter (for example, see JP-A-2006-246262). According to this method, the one-to-one relation at the optical signal level can be secured in the communication between OLT and ONUs, and therefore, the confidentiality problem of the PON is solved. Also, as long as an optical switch with a small loss can be fabricated, the problem of the decreased optical signal strength is expected to be also overcome.

The problem of the access network using an optical switch, unlike the PON system, is how the system controls the change-over operation of the optical switch in keeping with the timing at which the transmission/reception frames pass the optical switch. To cope with this problem, a method has been proposed by IEEE Std 802.3ah™-2004 in which the MPCP (Multi-point control protocol) is monitored by an optical switch unit to switch the optical switches (IEICE TRANS. COMMUN. VOL. E89-B, No. 3, pp. 724-730, MARCH 2006).

According to IEEE Std 802.3ah™-2004, the LLID (Logical Link Identifier) described in the preamble of the MPCP frame is read to determine the output optical switch port, and the downstream light switch is turned by inputting an activation signal in such a manner as to switch to the corresponding port of the downstream optical switch. In this process, the MPCP frame is required to be delayed before being input to the downstream optical switch by the reading process time and the activation signal input time. To realize this delay, the optical fiber delay line as long as 65 m, for example, is required (The 2006 Communication Society Conference B-8-12, The Institute of Electronics, Information and Communication Engineers), thereby making it impossible to reduce the packaging space of the optical switchboard.

### SUMMARY OF THE INVENTION

An object of this invention is to provide an optical access network adapted to switch the optical line without a process for delaying the optical signal on the optical switchboard.

Another object of the invention is to provide an optical line switching control system for controlling the optical line switching operation without a process for delaying the optical signal on the optical switchboard.

In order to achieve the objects described above, according to an aspect of this invention, there is provided an optical access network comprising plural ONUs connected to plural user terminals, an OLT communicating with an IP network through an access gateway, an optical switching unit (OSW) for connecting the plural ONUs and the OLT by switching the optical line and a control line connecting the OLT and the OSW for controlling the change-over operation of the optical switches in the OSW, wherein the optical switch port information required to generate the optical switch activation signal are concentrated in the OLT, which in turn transmits the optical switch change-over control signal to the OSW before the transmission frame through the control line.

More specifically, in an optical line switching control system, the change-over operation is controlled before the timing at which the head of the frame passes through the optical switch in the OSW in such a manner that the optical line of the frame communicating with a destination terminal is switched to the ONU connected with the particular terminal. In the process, the downstream frame is transmitted by the OLT, and therefore, the pass timing is known to the OLT in advance. The upstream frame, on the other hand, is transmitted by the ONU, and therefore, the OLT, in order to be informed of the pass timing in advance, is required to know the propagation time between ONU and OSW, or actually, the round-trip time (RTT) equivalent to twice as long as the propagation time. This process is described in detail in IEEE Std 802.3ah™-2004 and not explained here.

According to another aspect of the invention, there is provided an optical line switching control system, wherein, in order to know the RTT between the ONU and the OSW, the ONU transmits a registration request frame (the MPCP frame with the instruction code described later constituting REGISTERsw_REQ) repeatedly at regular time intervals from time point t0 to t1 so that the OSW activates the upstream optical switch at time point t1 to pass the registration request frames arriving at and after time point 1, and the OLT regards, as the round-trip time (RTT) between the OSW and the ONU, the difference between the time point t2 at which the registration request frame firstly arrives and the time point t4 at which the registration request frame transmitted by the ONU at time point t1 arrives.

According to this invention, the OLT gives an optical line change-over command to the optical switch unit through the control line before frame transmission. Therefore, the optical fiber delay line on the optical switchboard is eliminated and a compact package of the optical switchboard is realized. Also, the upstream optical switch can measure the RTT between the OSW and the ONU without monitoring the frame, and therefore, the upstream O/E converter and the E/O converter are not required on the optical switchboard.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of the network configuration according to this invention.

FIG. 2 is a block diagram showing an optical line switching unit 30 according to an embodiment shown in FIG. 1.

FIG. 3 is a diagram showing an example of the configuration of a downstream optical switch 311 and an upstream optical switch 312 in FIG. 2.

FIG. 4 is a diagram showing the state of the optical switches shown in FIG. 3.

FIG. 5 is a block diagram showing the configuration of an OLT 40 according to an embodiment shown in FIG. 1.

FIG. 6 is a block diagram showing the configuration of an ONU 20 according to an embodiment shown in FIG. 1.

FIG. 7 is a diagram showing an example of an optical switch port management table included in an optical switch control circuit 408 of the OLT 40.

FIG. 8 is a diagram showing an example of the format for notifying the port number of the optical switch from the OLT to the OSW through a control line 70.

FIG. 9 is a diagram showing an example of the format of the MPCP frame (GATEsw) newly employed in the invention.

FIG. 10 is a diagram showing an example of the format of the MPCP frame (REGISTERsw_REQ) newly employed in the invention.

FIG. 11 is a diagram showing an example of the format of the MPCP frame (REGISTERsw) newly employed in the invention.

FIG. 12 is a diagram showing an example of the format of the MPCP frame (REGISTERsw_ACK) newly employed in the invention.

FIG. 13 is a diagram showing an example of the timing chart of the first discovery sequence according to the invention.

FIG. 14 is a diagram showing an example of the timing chart of the second and subsequent discovery sequences according to the invention.

FIG. 15 is a diagram showing an example of the optical switch change-over control sequence for normal data communication according to the invention.

FIG. 16 is a diagram showing an example of the processing flow in the OSW for RTTs measurement according to the invention.

FIG. 17 is a diagram showing an example of the processing flow in the ONU for RTTs measurement according to the invention.

FIG. 18 is a diagram showing an example of the processing flow in the OLT for RTTs measurement according to the invention.

FIG. 19 is a diagram showing an example of the network configuration according to the invention.

FIG. 20 is a block diagram showing the configuration of an optical line switching unit 30-A according to an embodiment shown in FIG. 19.

FIG. 21 is a block diagram showing the configuration of an OLT 40-A according to an embodiment shown in FIG. 19.

FIG. 22 is a diagram showing an example of the format of the MPCP frame (DRIVE) newly employed in the invention.

FIG. 23 is a diagram showing an example of the timing chart of the first discovery sequence according to the invention.

FIG. 24 is a diagram showing an example of the timing chart of the second and subsequent discovery sequences according to the invention.

FIG. 25 is a diagram showing an example of the timing chart of the optical switch change-over control sequence for normal data communication according to the invention.

### DETAILED DESCRIPTION OF THE EMBODIMENTS

Embodiments of the invention are described below with reference to the drawings.

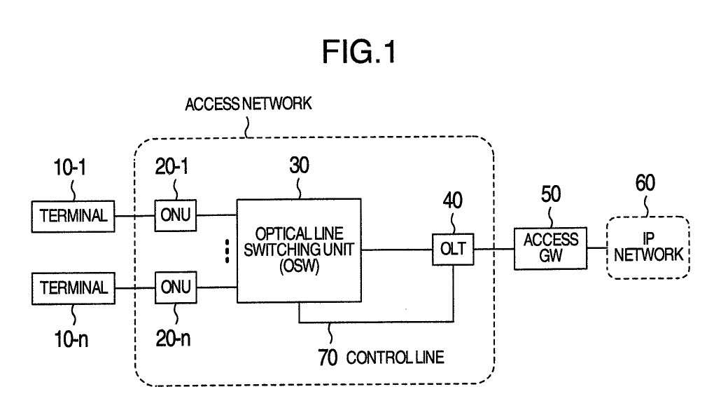

FIG. 1 shows an example of the network configuration according to this invention.

In FIG. 1, the optical access network includes optical network units (ONU) designated by reference numeral 20 (20-1 to 20-n), an optical line switching unit (OSW) designated by numeral 30, an optical line terminal (OLT) designated by numeral 40 and a control line 70 for connecting the OSW 30 and the OLT 40, all of which constitute an optical line switching control system according to the invention. User terminals 10 (10-1 to 10-n) are connected to an IP network 60 through the optical access network and an access gateway (GW) 50.

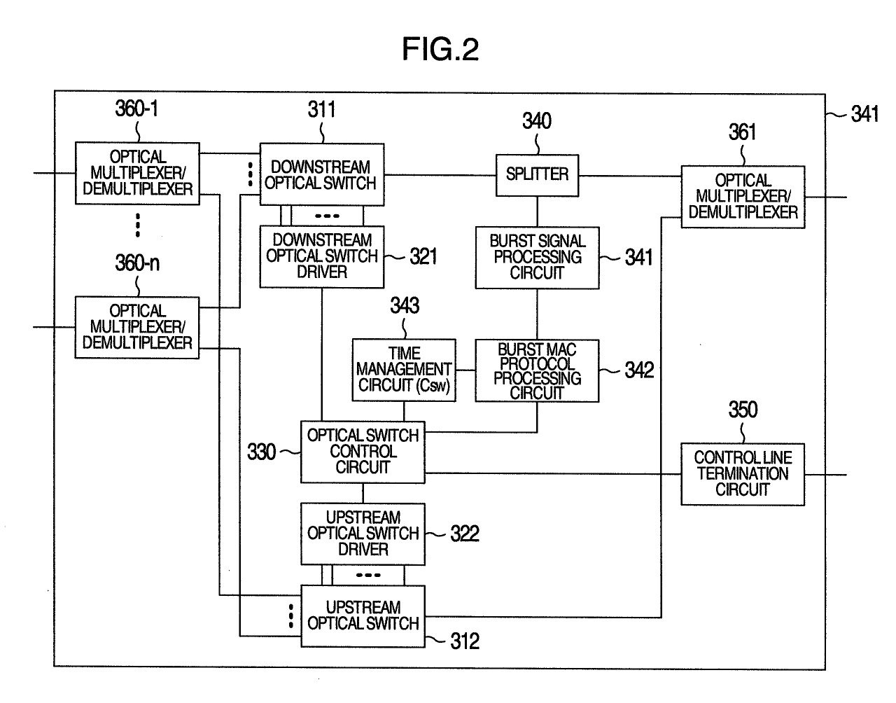

FIG. 2 is a block diagram showing the optical line switching unit 30 according to an embodiment.

The OSW 30 includes ONU-side optical multiplexer/demultiplexers 360 (360-1 to 360-n) and an OLT-side optical multiplexer/demultiplexer 361 for separating the wavelength division multiplex optical signal into a downstream optical signal and an upstream optical signal to switch the upstream and the downstream individually, a downstream optical switch 311 and an upstream optical switch 312 for switching the optical line, and a downstream optical switch driver 321 and an upstream optical switch driver 322 constituting a circuit for activating the optical switches. According to this invention, as described later, the OLT notifies, through the control line, the switch port information for generating the optical switch driver activation signal. For this purpose, the OSW 30 includes a control line termination circuit 350 connected to an optical switch control circuit (a driver input generation logic circuit) 330. Also, according to this invention, as described later, the upstream optical switch is turned at time point t1 to measure the RTT in the discovery sequence. In the first place, the OSW 30 includes a splitter 340, a burst signal processing circuit 341 and a burst MAC protocol processing circuit 342 for monitoring the downstream signal to read the time point t1 described in the downstream MPCP frame. Next, an activation signal is input to the optical switch 322 through the optical switch control circuit 330 at time point t1 managed by a time management circuit 343.

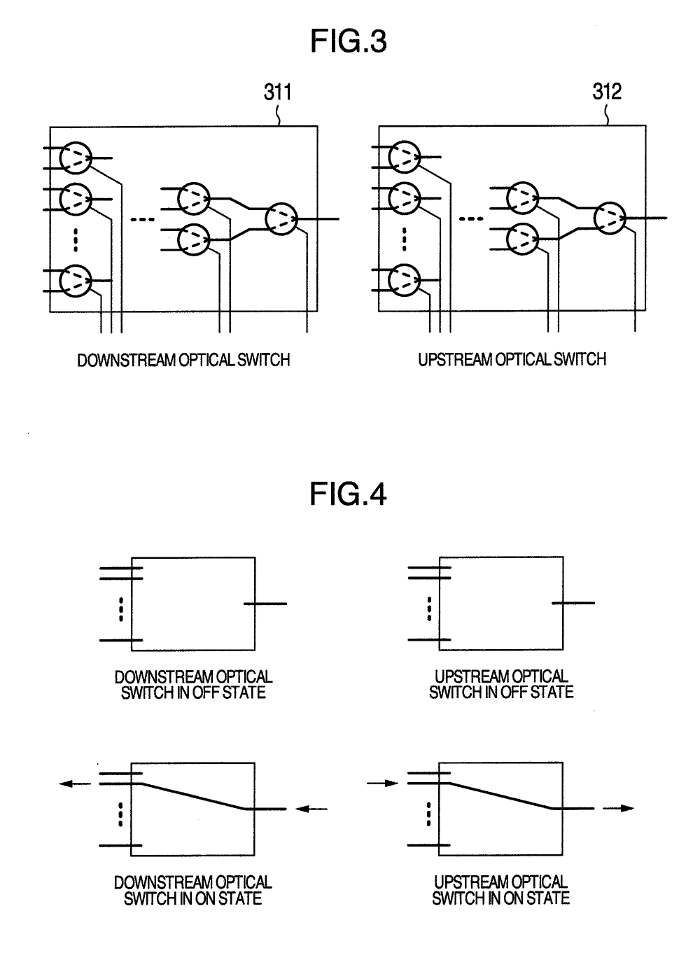

FIG. 3 shows an example of the configuration of the downstream optical switch 311 and the upstream optical switch 312 shown in FIG. 2. Both switches have the (1×n) configuration as an example realized by the tree connection of (1×2) units of the optical switches. Any optical switch may be used as long as the (1×n) configuration can be logically realized.

FIG. 4 shows the state of the optical switches shown in FIG. 3. Both the downstream optical switch and the upstream optical switch have an off state in which the optical signal fails to pass (communicate) from the input port to the output port. Also, the downstream optical switch has the state in which the optical signal passes from the input port to a specified output port, and the upstream optical switch has the state in which the optical signal passes from a specified input port to the output port.

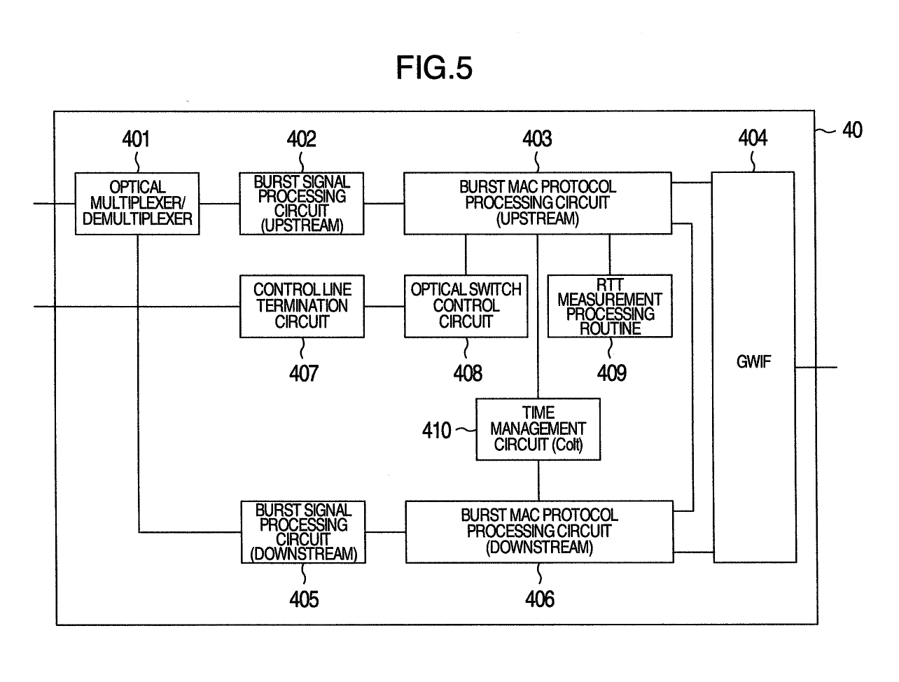

FIG. 5 is a block diagram showing the OLT 40 according to an embodiment.

The OLT 40 includes an optical multiplexer/demultiplexer 401 for separating the wavelength division multiplex transmission signal into upstream and downstream optical signals or merging the upstream and downstream optical signals, an upstream burst signal processing circuit 402, a burst MAC protocol processing circuit 403, a downstream burst signal processing circuit 405, a burst MAC protocol processing circuit 406, a gateway interface (GWIF) 404 and a time management circuit 410. The OLT 40 also includes an optical switch control circuit 408 and a RTT measurement processing routine 409 as essential part blocks of the invention. The OLT 40 further includes a control line termination circuit 407 to notify the OSW of the switch port information for generating the optical switch driver activation signal.

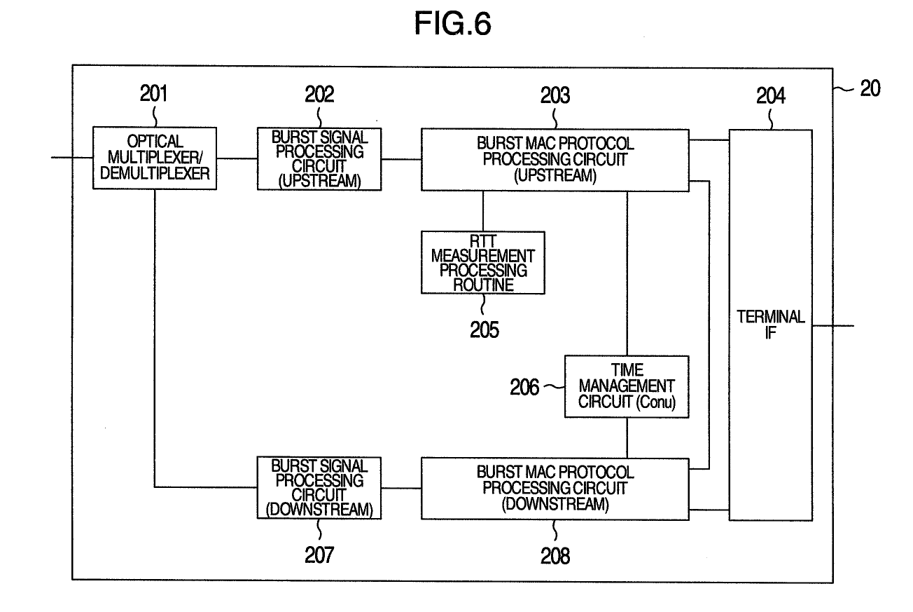

FIG. 6 is a block diagram showing the ONU 20 according to an embodiment.

The ONU 20 includes an optical multiplexer/demultiplexer 201 for separating the wavelength division multiplex transmission signal into upstream and downstream optical signals or merging the upstream and downstream optical signals, an upstream burst signal processing circuit 202, a burst MAC protocol processing circuit 203, a downstream burst signal processing circuit 207, a burst MAC protocol processing circuit 208, a terminal interface 204 and a time management circuit 206. The ONU 20 also includes a RTT measurement processing routine 205 as an essential part block of the invention.

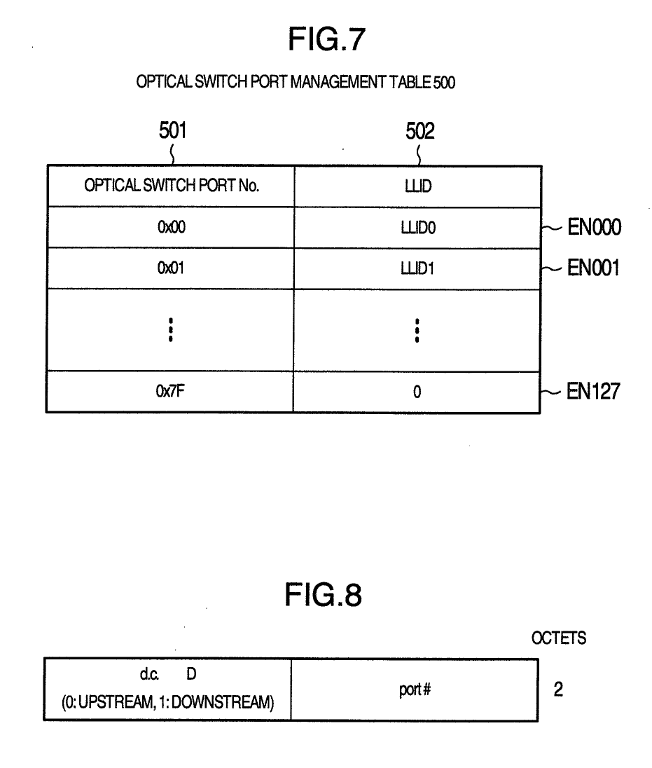

FIG. 7 shows an example of the table held in the optical switch control circuit 408 of the OLT 40 for managing the port numbers of the optical switches. The optical switch port management table 500 includes plural entries (EN000, EN001, . . . , EN127) each indicating the correspondence between the optical switch port number 501 and the LLID 502.

FIG. 8 shows an example of the format of the control signal applied by the OLT to the OSW through the control line 70. Any multipurpose optical line can be used as the control line. The Ethernet™ is an example. The bit D (upstream for D=0, and downstream for D=1) indicating the upstream or downstream path and the port number (port #) are described in the payload.

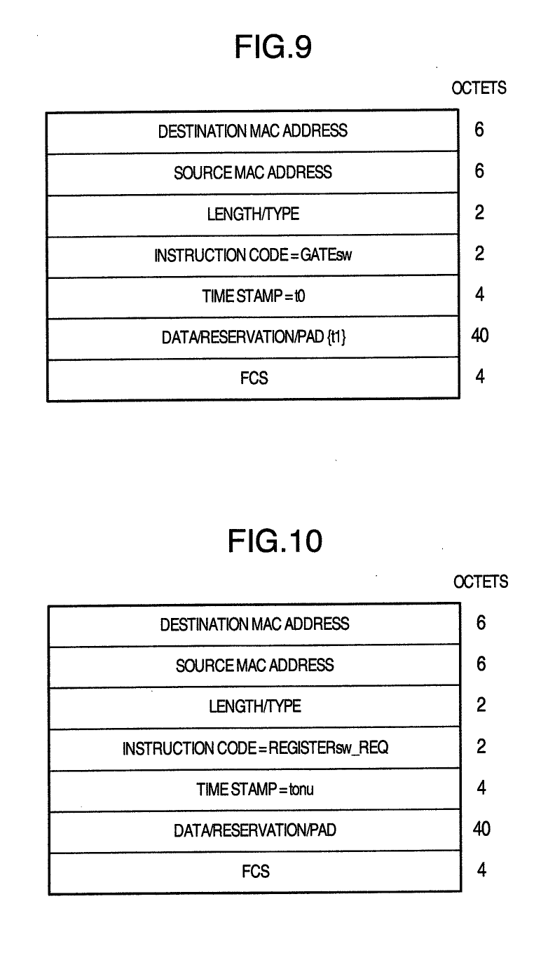

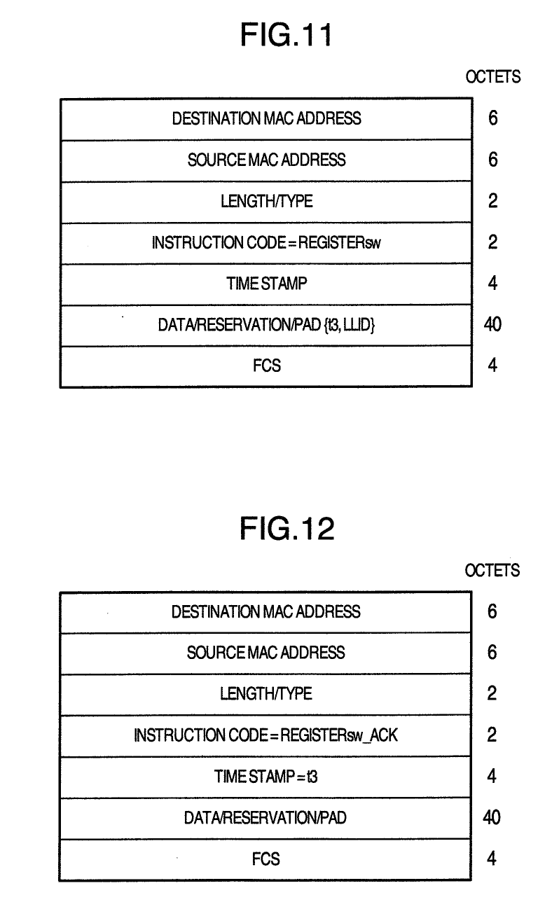

FIGS. 9 to 12 show examples of the format of the MPCP frame newly employed by the invention. FIG. 9 shows a message transmitted by the OLT to the ONUs in the discovery sequence described later. This message has a new instruction code GATEsw, a time stamp t0 and a RTT measurement ending time point t1 in the data field. FIG. 10 shows a message which is transmitted by each ONU to the OLT and has a new instruction code REGISTERsw_REQ with the transmission time point “tonu” as a time stamp. FIG. 11 shows a LLID allocation message transmitted from the OLT to the ONU which has a new instruction code REGISTERsw with the grant starting time point t3 and the LLID described in the data field. FIG. 12 shows a registration completion message transmitted from each ONU to the OLT, which has a new instruction code REGISTERsw_ACK with the time stamp of t3.

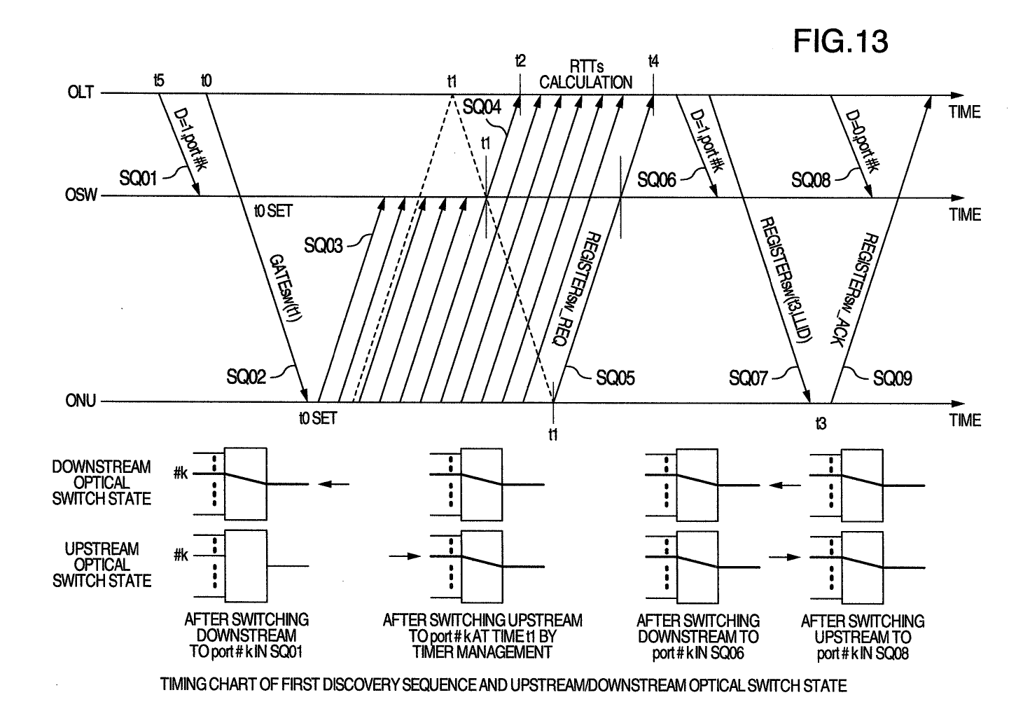

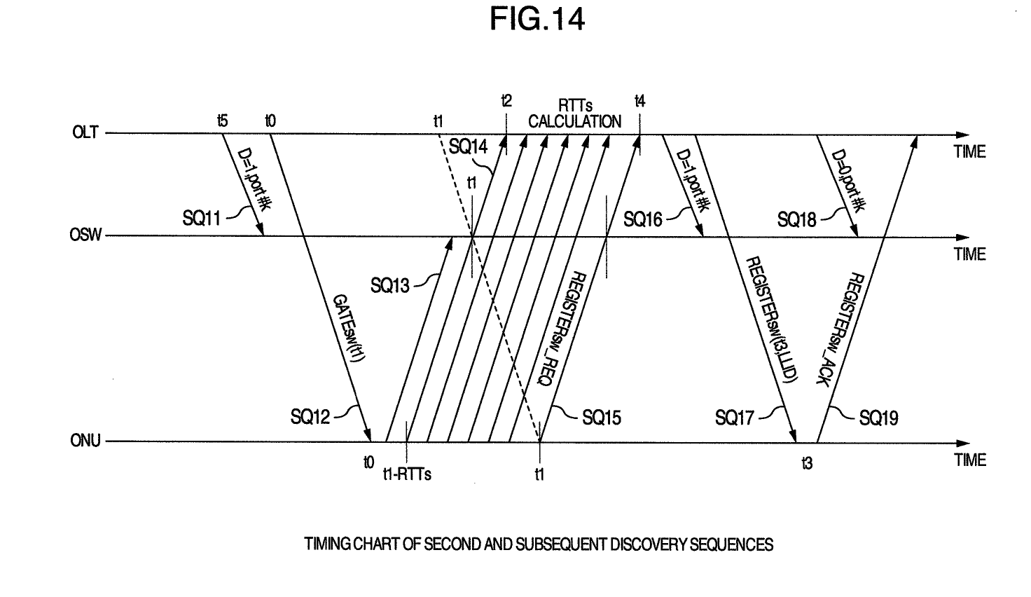

Next, the switching control timing of the optical switches is explained with reference to FIGS. 13 to 15.

FIG. 13 is a timing chart showing the first discovery sequence according to the invention and the state of the upstream/downstream optical switches (FIG. 4). The RTT (hereinafter referred to as RTTs) between the ONU involved and the OSW is measured in this sequence. Assume that the port of the optical switch intended for discovery is No. k and that the OLT notifies the OSW of the port number and the switch involved (down) in the format shown in FIG. 8 through the control line 70 at time point t5, and the OSW switches the downstream optical line to port No. k (SQ 01). The subsequent state of the downstream optical switch, as shown in FIG. 13, is the signal passed to the output port No. k. Next, while predicting the driver activation signal input time of the optical switch and the rise time of the drive signal, the OLT transmits the new frame GATEsw(t1) message of MPCP at time point t0 to the OSW in the format shown in FIG. 9. The OSW monitors this message and reads the time point t1, while at the same time setting the time stamp t0 on the local counter. The ONU that has been switched to the port No. k and has received the frame sets the time stamp t0 in the local counter (SQ 02). The temporal synchronization method is the same as described in IEEE Std 802.3ah™-2004, and by setting the time stamp in the local counter, the OLT, the OSW and the ONU are synchronized with each other in the phase shifted by the propagation delay time. The ONU that has received the GATEsw(t1) message immediately and repeatedly transmits the new REGISTERsw_REQ frame of MPCP at regular time intervals in the format shown in FIG. 10 until the time point t1 at which it is read from the GATEsw message (SQ 03 to SQ 05). The OSW is supplied with the activation signal in such a manner as to turn the upstream optical switch from the off state (the state not communicating with port No. k or the state communicating with other ports) to the state communicating with the input port No. k and at time point t1 into the state where the optical signal is passed from the input port No. k to the output port as shown. In the OLT, the arrival time of the first arriving REGISTERsw_REQ frame is set to t2 (SQ 04). Also, the arrival time of the REGISTERsw_REQ frame transmitted by the ONU at time point t1 is set to t4 (SQ 05). As apparent from FIG. 13, the difference between t4 and t2 constitutes the RTT (RTTs) between the ONU and the OSW. Next, the OLT allocates the LLID to the particular ONU and stores the allocated LLID in the entry of the optical switch port No. k in the optical switch port management table 500. The OLT activates the downstream optical switch in the same manner as in SQ 01 to communicate with the output port No. k (SQ 06), and notifies the allocated LLID to the ONU with the new MPCP frame REGISTERsw(t3, LLID) (SQ 07). The notification format is shown in FIG. 11. The ONU notifies the completion of the registration to the OLT at time point t3 with the new MPCP frame REGISTERsw_ACK (SQ 09). The notification format is shown in FIG. 12. In the process, the upstream optical switch activation timing in the OSW is t3+RTTs. At this timing with the prediction of the activation signal input time and the drive signal rise time, therefore, the OLT notifies the port No. k and the switch involved (upstream) to the OSW in the format shown in FIG. 8 to switch the OSW in such a manner that the input port No. k of the upstream optical switch may communicate with the output port (SQ 08).

In the first discovery sequence, the time after the estimated maximum time delay from the frame transmission at time point t0 is required to be designated as t1 by the OLT. In the second and subsequent sequences, however, the RTTs is known, and therefore, t1 can be reduced to t0+RTTs. The timing chart of the second and subsequent discovery sequences is shown in FIG. 14. Here, SQ 11 through SQ 19 in FIG. 14 correspond to SQ 01 through 09 in FIG. 13, respectively.

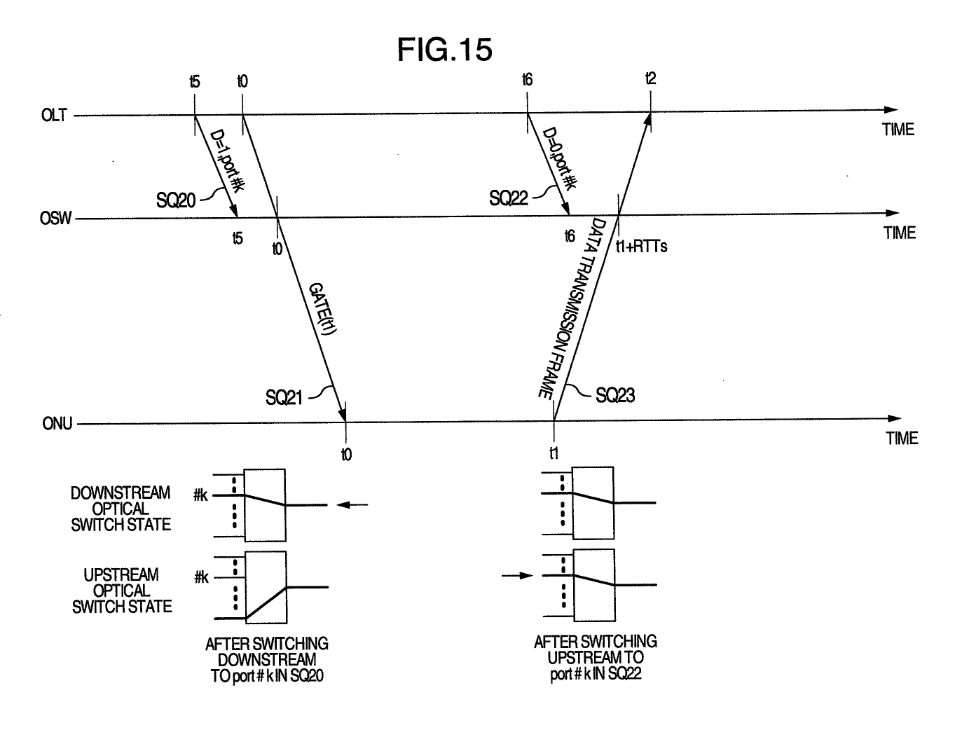

FIG. 15 is a timing chart of the optical switch change-over control sequence at the time of transferring the normal data transmission frame in upstream direction. The OLT notifies the OSW of the port number and the switch involved (downstream) in the format shown in FIG. 8 through the control line 70 at time point t5, and the OSW is supplied with the activation signal to switch the optical line in such a manner as to communicate with the corresponding output port of the downstream optical switch (SQ 20). Immediately after this process, the optical switch is in such a state that the downstream optical switch communicates with the corresponding port (the port No. k in the case under consideration). In the upstream optical switch, on the other hand, the input port No. k is not necessarily in on state. Next, the OLT transmits the GATE(t1) frame of the MPCP to the ONU at time point t0 (SQ 21). The ONU begins to transmit the data at time point t1 (SQ 23), and the OLT notifies the OSW of the port number and the switch involved (upstream) in the format shown in FIG. 8 through the control line 70 at time point t6, i.e. the time point t1+RTTs less the activation time. Then, the OSW is supplied with the activation signal and switches the optical line in such a manner that the corresponding input port of the upstream optical switch is in on state (SQ 22). Immediately after this process, the optical switches are in such a state that, as shown in FIG. 15, the corresponding port of the upstream optical switch (the port No. k in the case under consideration) is in on state. The downstream optical switch, on the other hand, is not necessarily in the state communicating with the input No. k. In the manner described above, the frame carrying the data can reach the OLT (SQ 23).

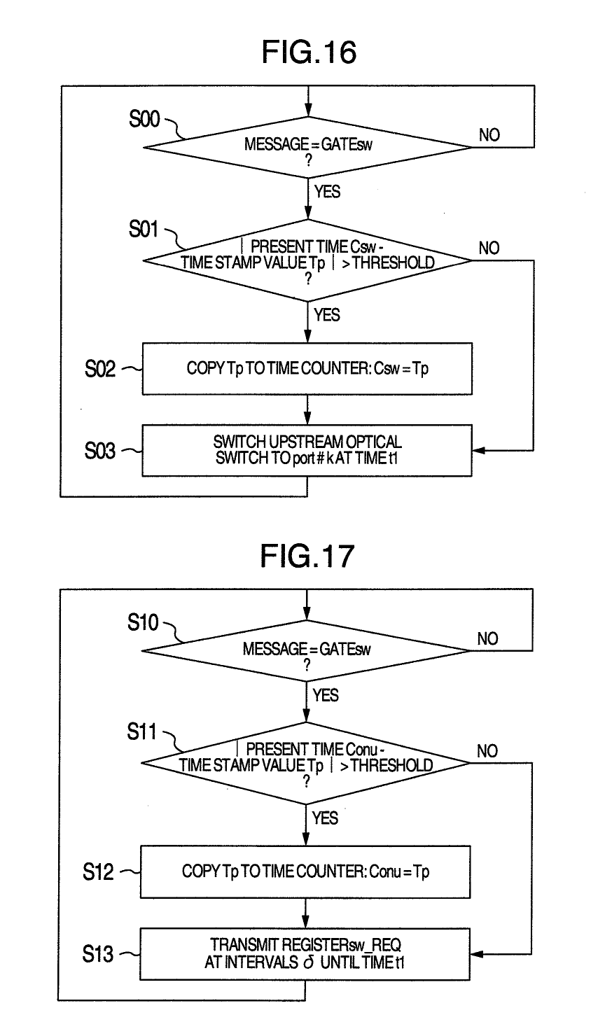

Next, the RTTs measurement flow is explained with reference to FIGS. 16 to 18.

FIG. 16 shows the flow of the RTTs measurement processing routine in the burst MAC protocol processing circuit 342 of the OSW 30. This process utilizes the local counter Csw held in the time management circuit 343. Upon judgment whether the MPCP frame is the GATEsw or not (step S00), and the process proceeds to step S01 in the case where the answer is YES, while in the case where the answer is NO, the process returns to S00. In step S01, assume that the absolute value of the difference between the value on the local counter Csw indicating the present time and the time stamp Tp read from the GATEsw is larger than a predetermined threshold value. Then, the process proceeds to step S02 to repeat the temporal synchronization. Otherwise, the process skips the temporal synchronization and proceeds to step S03. In step S02, the time stamp value Tp that has been read is copied to the time counter Csw for temporal synchronization, followed by proceeding to step S03. In step S03, the upstream optical switch is turned to the port No. k at the time point t1 at which it is read from the GATEsw, and then the process returns to step S00.

FIG. 17 shows the flow of the RTTs measurement processing routine in the RTT measurement processing routine 205 of the ONU 20. The process utilizes the upstream burst MAC protocol processing circuit 203, the downstream burst MAC protocol processing circuit 207 and the local counter “Conu” held by the time management circuit 206. First, step S10 judges whether the MPCP frame read by the downstream burst MAC protocol processing circuit 203 is the GATEsw or not, and in the case where the answer is YES, the process proceeds to step S11, while in the case where the answer is NO, the process returns to step S10. In step S11, assume that the absolute value of the difference between the value on the local counter Conu indicating the present time read by the time management circuit 206 and the time stamp value Tp read from the GATEsw is larger than a predetermined threshold value. Then, the process proceeds to step S12 to repeat the temporal synchronization. Otherwise, the process proceeds to step S13 by skipping the temporal synchronization step. In step S12, the time stamp value Tp that has been read is copied to the time counter Conu to carry out the temporal synchronization, followed by proceeding to step S13. In step S13, the upstream burst MAC protocol processing circuit 203 transmits the REGISTERsw_REQ of the new MPCP frame at regular time intervals δ in the format shown in FIG. 11 until time point t1, and then, the process returns to step S10.

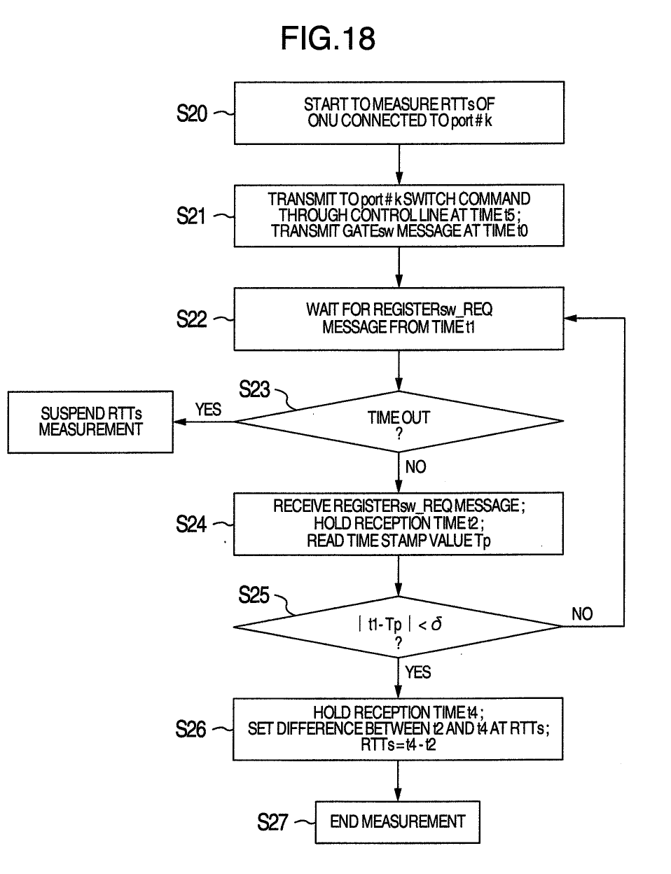

FIG. 18 shows the flow of the RTTs measurement processing routine in the RTT measurement process routine 409 of the OLT 40. This process utilizes the upstream burst MAC protocol processing circuit 403 and the local counter “Colt” held in the time management circuit 410. Step S20 starts to measure the RTTs of the ONU connected to the port No. k. Before transmitting the GATEsw frame at time point t0, a command is issued through the control line 70 to switch to the port No. k at time point t5, and the upstream burst MAC protocol processing circuit 409 transmits the GATEsw frame at time point t0 (S21), followed by proceeding to step S22. Step S22 waits from time point t1 until the reception of the REGISTERsw_REQ frame transmitted from the ONU. In step S23, the RTTs measurement is suspended if time runs out. Unless the time runs out, on the other hand, the process proceeds to step S24. In step S24, the upstream burst MAC protocol processing circuit 409 holds the time point t2 at which the GATEsw frame is received, and reads the time stamp value Tp, followed by proceeding to step S25. In step S25, assuming that the absolute value of the difference between t1 and Tp is not smaller than δ, the REGISTERsw_REQ frame is regarded as the last one and the process proceeds to step S26. Otherwise, the process returns to step S22 and waits for the reception of the next REGISTERsw_REQ frame. Step S26 holds the time point t4 at which the last REGISTERsw_REQ frame is received, and determines the difference thereof with the time point t2 held as RTTs. Now, the RTTs measurement is over (step S27).

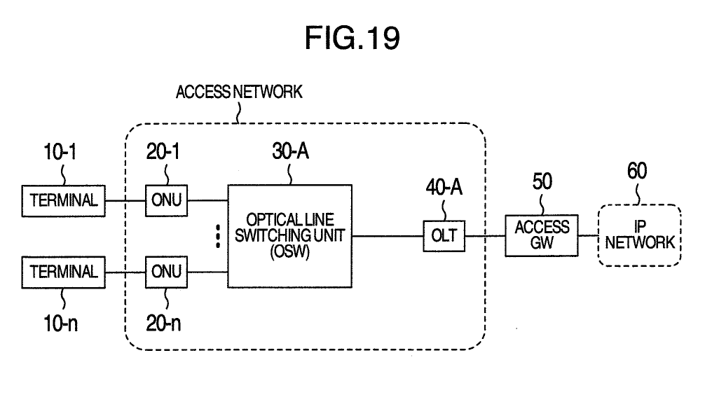

The embodiment described above represents a case in which a command to turn the optical switch (hereinafter referred to as the optical switch change-over command) is given, i.e. the state control signal is transmitted through the control line 70. Nevertheless, the optical switch change-over command may be given in a specially defined control frame without using the control line. An embodiment using no control line is explained below with reference to FIGS. 19 to 25.

FIG. 19 shows an example of the network configuration.

This configuration, through free of the control line 70 shown in FIG. 1, is identical with the configuration of FIG. 1 except for the optical line switching unit 30-A (OSW) and the optical line terminal (OLT) 40-A.

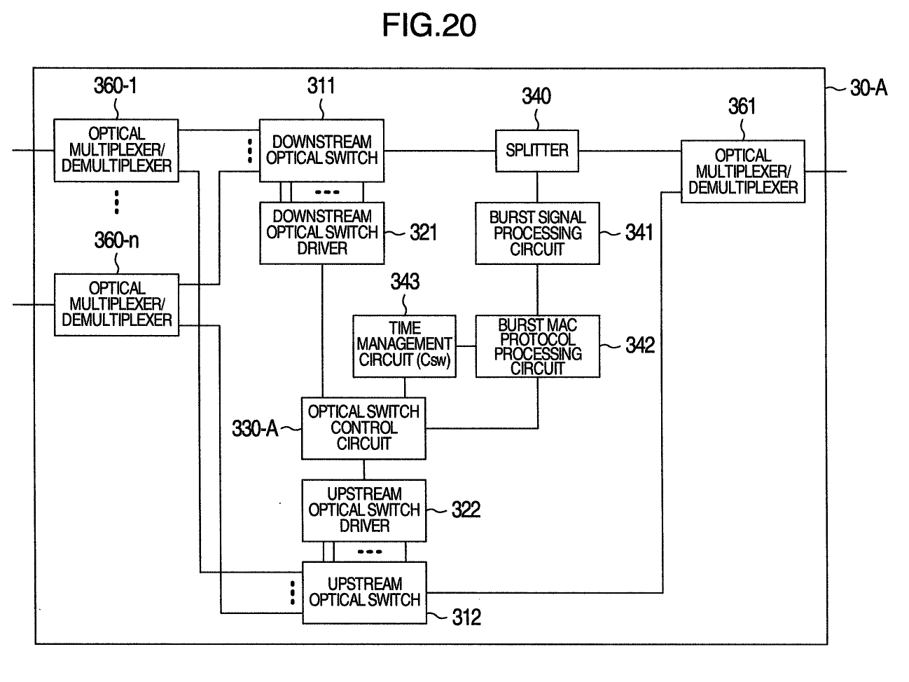

FIG. 20 is a block diagram showing the optical line switching unit 30-A according to an embodiment.

The OSW 30-A includes ONU-side optical multiplexer/demultiplexers 360 (360-1 to 360-n) and an OLT-side optical multiplexer/demultiplexer 361 for separating the wavelength division multiplex optical signal into downstream and upstream optical signals to switch the upstream and the downstream individually, a downstream optical switch 311 and an upstream optical switch 312 for switching the optical line, and a downstream optical switch driver 321 and an upstream optical switch driver 322 constituting a circuit for activating the optical switches. Also, in order to read the time point t1 described in the downstream MPCP and required for RTTs measurement and the optical switch change-over command in the control frame described later, the OSW 30-A also includes a splitter 340 for monitoring the downstream signal, a burst signal processing circuit 341 and a burst MAC protocol processing circuit 342. Also, in order to turn the optical switch at time point t1, an activation signal is input to the upstream optical switch 322 through the optical switch control circuit 330-A at time point t1 managed by the time management circuit 343. In the case where the optical switch change-over command is given in the control frame, on the other hand, an activation signal is input to the upstream optical switch 322 through the optical signal control circuit 330 at the timing of arrival of the control frame.

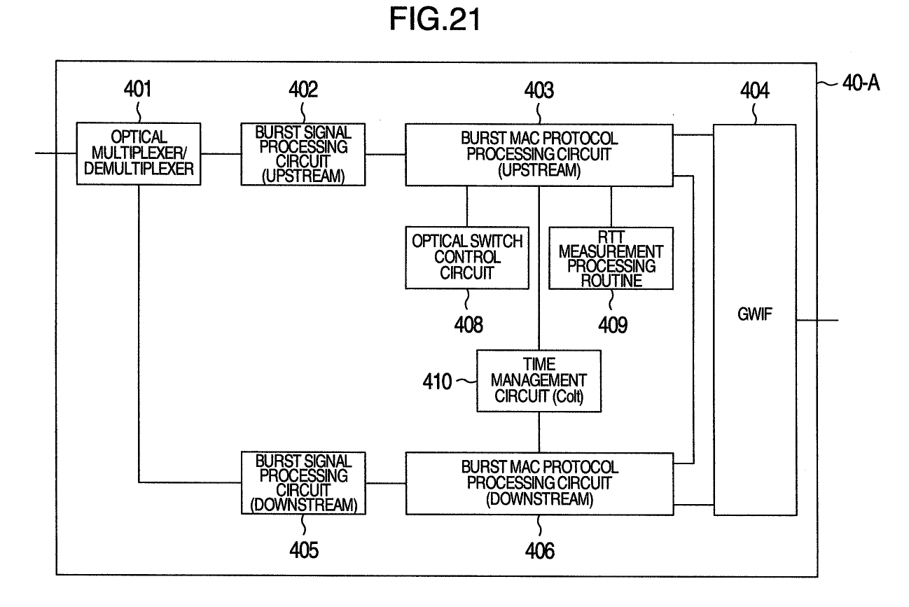

FIG. 21 is a block diagram showing the configuration of the OLT 40-A according to an embodiment.

The OLT 40-A includes an optical multiplexer/demultiplexer 401 for separating the wavelength division multiplex transmission signal into and merging an upstream optical signal and a downstream optical signal, an upstream burst signal processing circuit 402, a burst MAC protocol processing circuit 403, a downstream burst signal processing circuit 405, a burst MAC protocol processing circuit 406, a gateway interface (GWIF) 404 and a time management circuit 410. Also, the OLT 40-A includes an optical switch control circuit 408 and a RTT measurement processing routine 409 as the essential part blocks of the invention. In order to generate a control frame for notifying the OSW of the switch port information for preparing an optical switch driver activation signal, the optical switch control circuit 408 is connected to the burst MAC protocol processing circuit 406.

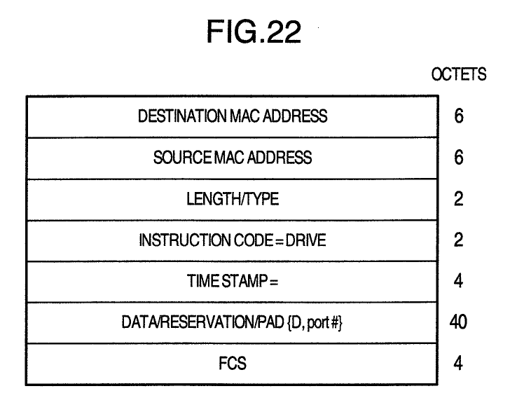

FIG. 22 shows the format of the new MPCP frame transmitted from the OLT to the OSW to issue the optical switch change-over command in the control frame. This format includes a new instruction code DRIVE, and the data field thereof contains the description of the bit D (D=0 for upstream, and D=1 for downstream) indicating upstream or downstream as the same information as in FIG. 8 and the port No. (port #).

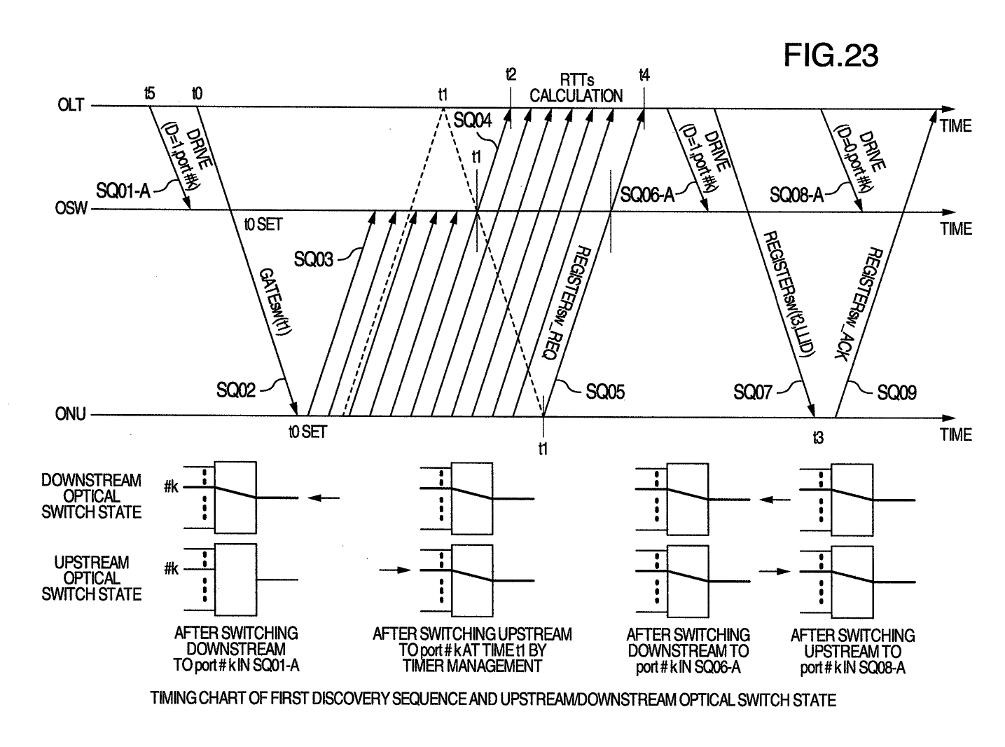

Next, the optical switch change-over control sequence based on the command in the control frame is explained with reference to FIGS. 23 to 25. This sequence is different from the one shown in FIGS. 13 to 15 only in the format of the sequence of the change-over command from the OLT to the OSW, and the other points are shared by both sequences.

FIG. 23 shows the timing chart of the first discovery sequence and the state of the upstream/downstream optical switches (FIG. 4). Assume that the port of the optical switch to be discovered is No. k, the OLT notifies the OSW of the new frame DRIVE(D, port #) of the MPCP in the format of FIG. 22 at time point t5, and the OSW switches downstream optical line to the port No. k (SQ 01-A). The subsequent state of the optical switch is communicating with the output port No. k. Next, with the prediction of the optical switch driver activation signal input time and the drive signal rise time, the OLT transmits the new frame GATEsw(t1) of the MPCP to the OSW at time point t0 in the format shown in FIG. 9. The OSW monitors this message and reads the time point t1, while at the same time setting the time stamp t0 in the local counter to connect to the port No. k switched. Thus, the ONU that has received the frame sets the time stamp t0 in the local counter (SQ 02). The same temporal synchronization method is employed as described in IEEE Std 802.3ah™-2004, and by setting the time stamp in the local counter, the OLT, the OSW and the ONU are synchronized with each other in a phase shifted by the propagation delay time. The ONU that has received the GATEsw(t1) message immediately and repeatedly transmits the new REGISTERsw_REQ frame of the MPCP at regular time intervals in the format of FIG. 10 until the time point t1 at which it is read form the GATEsw message (SQ 03 to SQ 05). The OSW is supplied with the activation signal in such a manner that the upstream optical switch is turned from the off state (the state not communicating with the input port No. k or communicating with other ports) to the input port No. k at time t1 and thereby sets the optical signal from the input port No. k to communicate with the output port as shown in the FIG. 23. In the OLT, the arrival time of the first-arriving REGISTERsw_REQ frame is set to t2 (SQ 04). Also, The arrival time of the REGISTERsw_REQ frame transmitted by the ONU at time point t1 is set to t4 (SQ 05). As apparent from FIG. 23, the difference between t4 and t2 constitutes the RTT (RTTs) between the ONU and the OSW. Next, the OLT allocates the LLID to the corresponding ONU, and the LLID thus allocated is stored in the entry of port No. k of the optical switch in the optical switch port management table 500. The OLT activates the downstream optical switch in the same manner as in SQ 01-A to communicate with the output port No. k (SQ 06-A), and notifies the allocated LLID to the ONU with the new MPCP frame REGISTERsw(t3, LLID) (SQ 07). The notification format is shown in FIG. 11. The ONU notifies the registration completion to the OLT with the new MPCP frame REGISTERsw_ACK at time point t3 (SQ 09). The notification format is shown in FIG. 12. In the process, the upstream optical switch is activated at the timing t3+RTTs in the OSW. At this timing with the prediction of the activation signal input time and the drive signal rise time, therefore, the OLT notifies the port No. k and the switch involved (upstream) to the OSW in advance in the format shown in FIG. 22. Thus, the OSW is turned in such a manner that the input port No. k of the upstream optical switch communicates with the output port (SQ 08-A),

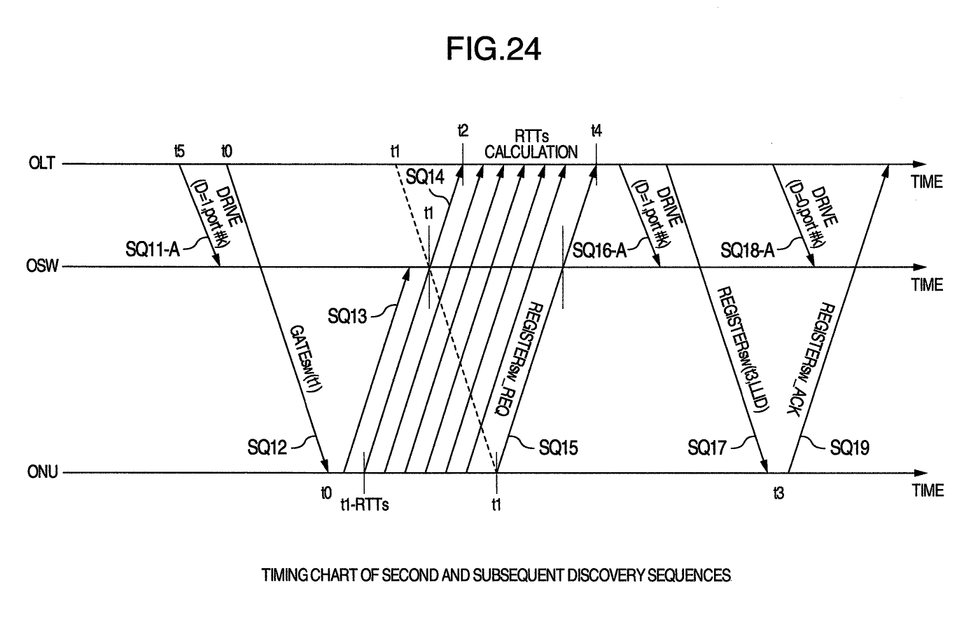

In the first discovery sequence, the time point upon lapse of the maximum estimated delay time from the frame transmission at time point t0 is required to be designated as t1 by the OLT. In the second and subsequent sequences, however, the RTTs is known, and therefore, t1 can be reduced to t0+RTTs. The timing chart of the second and subsequent discovery sequences is shown in FIG. 24. Here, SQ 11-A through SQ 19 in FIG. 24 correspond to SQ 01-A through SQ 09 in FIG. 23, respectively.

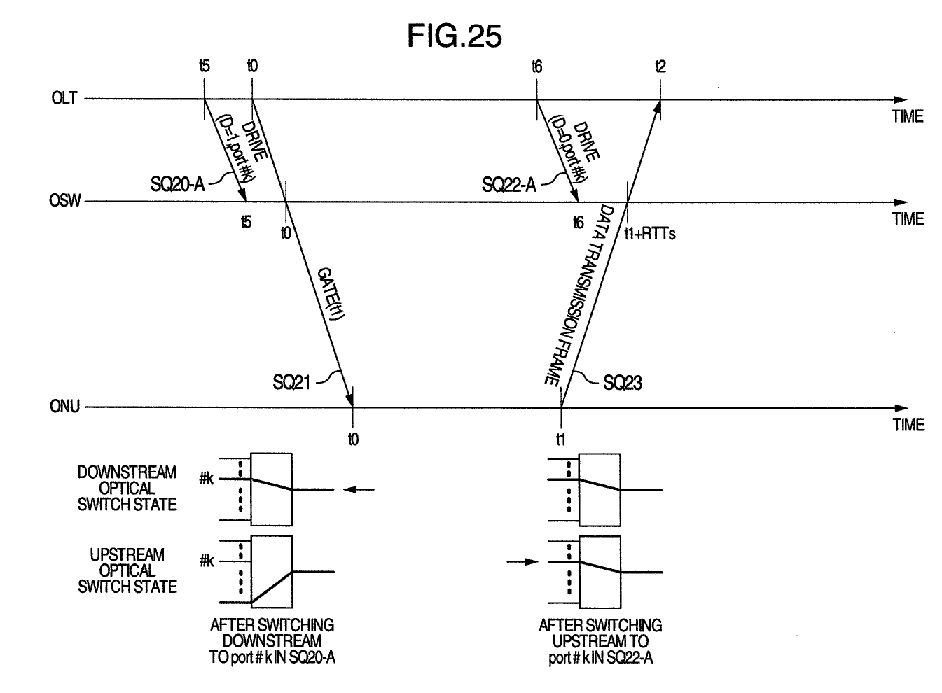

FIG. 25 shows the timing chart of the optical switch change-over control sequence for transferring the normal data transmission frame in the upstream direction. The OLT transmits the new MPCP frame DRIVE(D, port #) to the OSW at time point t5 in the format shown in FIG. 22, and the OSW is supplied with the activation signal to switch the optical line in such a manner as to communicate with the corresponding output port of the downstream optical switch (SQ 20-A). Immediately after this process, the downstream optical switch, as shown in FIG. 25, is in the state communicating with the corresponding port (No. k in this embodiment). The upstream optical switch, on the other hand, is not necessarily in the state communicating with the input port No. k. Next, the OLT transmits the GATE(t1) frame of the MPCP to the ONU at time point t0 (SQ 21). The ONU starts to transmit the data at time point t1 (SQ 23), and the OLT transmits the new MPCP frame DRIVE(D, port #) to the OSW in the format shown in FIG. 22 at time t6, i.e. the time point t1+RTTs less the activation time. Then, the OSW is supplied with the activation signal and switches the optical line in such a manner that the corresponding input port of the upstream optical switch is set in communication state (on state) (SQ 22-A). Immediately after this process, as shown in FIG. 25, the corresponding port (No. k in this embodiment) of the upstream optical switch is in the state of communication. The downstream optical switch, on the other hand, is not necessarily in the state communicating with port No. k. In the way described above, the frame carrying the data is rendered to reach the OLT (SQ 23).

It should be further understood by those skilled in the art that although the foregoing description has been made on embodiments of the invention, the invention is not limited thereto and various changes and modifications may be made without departing from the spirit of the invention and the scope of the appended claims.

1. An optical access network system comprising:
a plurality of ONUs (optical network units) connected to user terminals;
an OLT (optical line terminal) communicating with an IP network through an access gateway; and
an OSW (optical switching unit) having a plurality of optical switches for connecting the plurality of the ONUs and the OLT by switching an optical line;
wherein the OLT transmits an optical switch change-over control signal to the OSW; and
wherein the OSW switches the optical line based on the optical switch change-over control signal.

2. The optical access network system according to claim 1, further comprising:
a control line for connecting the OLT and the OSW to each other,
wherein the OLT transmits the optical switch change-over control signal to the OSW through the control line.

3. The optical access network system according to claim 1,
wherein the optical switch change-over control signal is a MPCP (multi-point control protocol) frame.

4. The optical access network system according to claim 1,
wherein the OLT includes a storage unit; and
wherein the information on the correspondence between the port number of each optical switch and a LLID (logical link identifier) is stored in the storage unit.

5. The optical access network system according to claim 1,
wherein the ONU transmits a plurality of registration request frames to the OLT;
wherein the OLT stores in the storage unit, as the RTT (round-trip time) between the OSW and the ONU, the difference between the time point t1 at which the first one of the plurality of the registration request frames arrives at the OLT by the change-over operation of the optical switches in the OSW and the time point t2 at which the one of the plurality of the registration request frames transmitted by the ONU at time point t1 from the ONU has arrived at the OLT; and
wherein the OLT controls, based on the RTT, the timing at which the optical switch change-over control signal is transmitted to the OSW.
